(19) United States
(12) Patent Application Publication
(10) Pub. No.: US 2026/0128656 A1
(43) Pub. Date: May 7, 2026

(54) STEP MOTOR

(71) Applicant: AAC Microtech (Changzhou) Co., Ltd., Changzhou City (CN)

(72) Inventors: Sensen Yang, Changzhou (CN); Jinguo Wu, Changzhou (CN); Junsheng Wang, Changzhou (CN)

(21) Appl. No.: 19/172,637

(22) Filed: Apr. 7, 2025

Related U.S. Application Data
(63) Continuation of application No. PCT/CN2024/129330, filed on Nov. 1, 2024.

(51) Int. Cl. H02K 37/14

(52) U.S. Cl. CPC H02K 37/14

(57) ABSTRACT

Provided is a stepping motor including a rotary shaft, a magnet fixed to an outer peripheral side of the rotary shaft, and a winding unit sleeved on the rotary shaft and forming a rotatable connection with the rotary shaft. The winding unit includes at least one winding. Each winding is disposed apart from the magnet, and includes a shell sleeved on the rotary shaft, a skeleton fixed to the shell, two first claw poles fixed to two ends of the shell, two second claw poles fixed to a middle region of the skeleton, and two coils wound around the skeleton and disposed at intervals. Two opposite sides of the shell of each winding each is provided with a slot penetrating through the sidewall of the shell. The stepping motor can increase the effective volume of the whole magnetic circuit, and improve the torque performance by around 15%.

### TECHNICAL FIELD

The present disclosure relates to the technical field of motors, and in particular, to a step motor applied to a foldable-screen mobile phone.

### BACKGROUND

Step motors have been widely used in most technical fields, such as electromotor field, electric generator field, and folding-related field, due to their advantages of compact structure, high efficiency, energy conservation and consumption reduction and the like.

In the folding-related field, as shown in FIG. 1, an automatic folding hinge 101 adopted by a foldable-screen mobile phone 100 needs to be realized by a step motor. To realize the lightness and thinness of the foldable-screen mobile phone 100, its thickness in the Z-axis direction needs to be further reduced, i.e., the arrangement space in the Z-axis direction needs to be reduced, whereas the arrangement space in the Y-axis direction is relatively loose and does not need to be further reduced. Under the condition that the arrangement space in the Z-axis direction is limited, to ensure that the automatic folding function of the foldable-screen mobile phone 100 is not affected, it is necessary to ensure that the step motor has a sufficiently large output torque.

In the related art, a motor 200 mainly includes a shaft body 210, a magnet 220 fixed to an outer peripheral side of the shaft body 210, a winding structure sleeved on the shaft body 210 and forming a rotatable connection with the shaft body 210, and a flexible circuit board fixed to the winding structure and forming an electrical connection with the winding structure, as shown in conjunction with FIG. 2 and FIG. 3. The winding structure includes four coil assemblies 230. Each of the coil assemblies 230 includes a housing 2301 sleeved on the shaft body 210 and formed by enclosing its sidewall, a bracket 2302 fixed to an inner side of the housing 2301, a first claw pole structure 2303 fixed to the housing 2301 and extending into the bracket 2302, a second claw pole structure 2304 fixed to the bracket 2302 and disposed directly opposite to the first claw pole structure 2303, a coil structure 2305 fixed to an outer side of the bracket 2302, and winding posts 2306 fixed to the outer side of the bracket 2302. The outer housing 2301 forms the rotatable connection with the shaft body 210 through cover plates 2307 and bearing bodies 2308. To limit the position of the second claw pole structure 2304, a small slot 240 needs to be designed in a side surface of the housing 2301. To allow the winding posts 2306 to pass through, a large slot 250 needs to be designed in the side surface of the housing 2301.

In conclusion, in the related art, the small slot 240 and the large slot 250 designed in the housing 2301 of the motor 200 each are to form an avoidance position. In the case that the size of the motor 200 in a single direction is limited, this design mode may cause the volumes of the magnet 220, the sidewall of the housing 2301, the first claw pole structure 2303, the second claw pole structure 2304, and the coil structure 2305 to be also limited by the size in the single direction, resulting in a smaller torque of the motor 200.

Therefore, it is necessary to provide a new step motor to solve the above technical problem.

### SUMMARY

An object of the present disclosure is to provide a new step motor to solve the problem in the related art that the design of the housing of the motor may result in a smaller torque.

In order to achieve the above object, the present disclosure provides a step motor including: a rotary shaft, a magnet fixed to an outer peripheral side of the rotary shaft, and a winding unit sleeved on the rotary shaft and forming a rotatable connection with the rotary shaft, the winding unit including at least one winding arranged along an axial direction of the rotary shaft, and each winding being disposed apart from the magnet; where each winding includes a shell sleeved on the rotary shaft and forming a rotatable connection with the rotary shaft, a skeleton fixed to an inner side of the shell and disposed coaxially with the shell, two first claw poles respectively fixed to two ends of the shell, two second claw poles fixed to a middle region of the skeleton, and two coils respectively wound around an outer peripheral side of the skeleton and disposed at intervals; the shell has an annular shape and is formed by enclosing its sidewall, each of the second claw poles extends into the skeleton and forms a fixed connection with the skeleton, each of the first claw poles is disposed opposite to and fit with a corresponding one of the second claw poles, and each of the coils is located at an outer side of a corresponding one of the first claw poles and an outer side of a corresponding one of the second claw poles; and two opposite sides of the shell of each winding each is provided with a slot penetrating through the sidewall of the shell.

As an improvement, the two second claw poles of each winding are each embedded into a corresponding skeleton, and are each integrally molded with the corresponding skeleton by insert injection molding.

As an improvement, the step motor further includes a flexible circuit board fixed to the winding unit and forming an electrical connection with the winding unit, where the flexible circuit board is fixed to the skeleton of each winding, and the flexible circuit board is electrically connected to all the coils of each winding.

As an improvement, the middle region of the skeleton of each winding is provided with an extension protruding and passing through the shell, where a side of the extension away from the skeleton is provided with four winding posts protruding at intervals, and the four winding posts are respectively inserted and fixed to the flexible circuit board; and two ends of each of the two coils of each winding are respectively wound around two of the four winding posts and form electrical connections with the flexible circuit board.

As an improvement, the winding posts and the extension of each winding are integrally molded with the skeleton by injection molding.

As an improvement, the magnet is a sintered magnet.

As an improvement, the step motor includes a plurality of magnets, the plurality of magnets are disposed around the rotary shaft and fixed to the outer peripheral side of the rotary shaft, and the plurality of magnets are arranged at intervals.

As an improvement, each of the first claw poles and each of the second claw poles each includes an annular fixed portion and a plurality of bending portions extending and bent from an inner periphery of the fixed portion along an axial direction of the fixed portion, and the plurality of bending portions are provided at intervals and all extend into the skeleton; and the bending portions of each of the first claw poles are each located between two of the bending portions of a corresponding one of the second claw poles, and the bending portions of each of the second claw poles are each located between two of the bending portions of a corresponding one of the first claw poles.

As an improvement, an inner side of the skeleton of each winding is provided with a plurality of grooves formed by recessing inward, the plurality of grooves respectively match the plurality of bending portions of each of the first claw poles and the plurality of bending portions of each of the second claw poles in shape, and the plurality of bending portions of each of the first claw poles and the plurality of bending portions of each of the second claw poles are each accommodated and fixed in a corresponding groove.

As an improvement, each of the first claw poles is integrally molded with the shell corresponding to the first claw poles.

As an improvement, the winding unit includes a plurality of windings arranged along the axial direction of the rotary shaft, the shells of the plurality of windings are fixedly connected to one another in sequence, and the respective slots of the plurality of windings lead to each other along the axial direction of the rotary shaft.

As an improvement, the shell of each winding includes a first shell and a second shell that are hollow and mutually overlapped along the axial direction of the rotary shaft, and the slots are respectively disposed in the first shell and the second shell; each of two outer windings of the windings further includes a cover body that covers and is fixed to one end of the first shell away from the second shell, in each of the two outer windings, the first shell is further away from another one of the windings than the second shell, the cover body is fixed to the rotary shaft through a bearing and forms a rotatable connection with the rotary shaft, and the cover body is provided with an inwardly recessed notch in a position of the cover body corresponding to the slots; and the two first claw poles of each winding are respectively disposed at an end of the first shell and an end of the second shell which are away from each other.

Compared with the related art, for the step motor in the present disclosure, each of the second claw poles is fixed to the skeleton to achieve position limitation, and the slots penetrating through the sidewall of the shell are provided on the two opposite sides of the shell to achieve avoidance in a single direction, so that the step motor can further expand the volumes of the magnet(s), the first claw poles, the second claw poles, and the coils when it is of the same size. Although the volume of the sidewall of the shell is reduced, on the whole, the space of the effective magnetic circuit formed by the magnet(s) and the coils is released, so that the effective volume of the entire magnetic circuit is increased, and the torque performance can also be improved by around 15%.

### BRIEF DESCRIPTION OF DRAWINGS

To more clearly illustrate the technical solutions in embodiments of the present disclosure, the accompanying drawings required to be used in the description of the embodiments will be briefly introduced below. Apparently, the accompanying drawings in the following description are merely some embodiments of the present disclosure, and for one of ordinary skill in the art, other accompanying drawings may also be obtained based on these accompanying drawings without any creative effort.

FIG. 1 is a schematic view of the structure of a foldable-screen mobile phone provided in the related art;

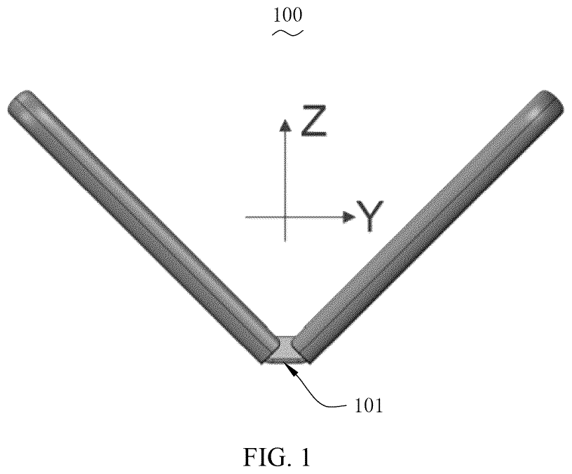

FIG. 2 is a perspective schematic view of the structure of a step motor provided in the related art;

FIG. 3 is an exploded schematic view of the structure of the step motor provided in the related art;

FIG. 4 is a perspective schematic view of the structure of a step motor provided by an embodiment of the present disclosure;

FIG. 5 is an exploded schematic view of the structure of the step motor provided by the embodiment of the present disclosure;

FIG. 6 is a sectional view taken along the line A-A in FIG. 4; and

FIG. 7 is a schematic view of the structure of a skeleton of the step motor of provided by the embodiment of the present disclosure.

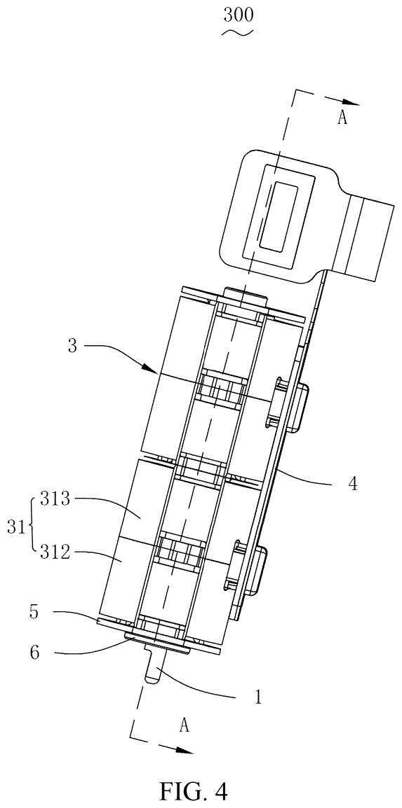

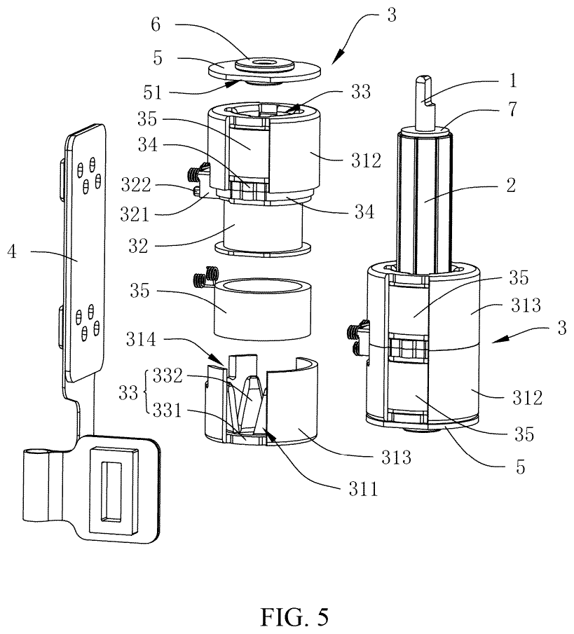

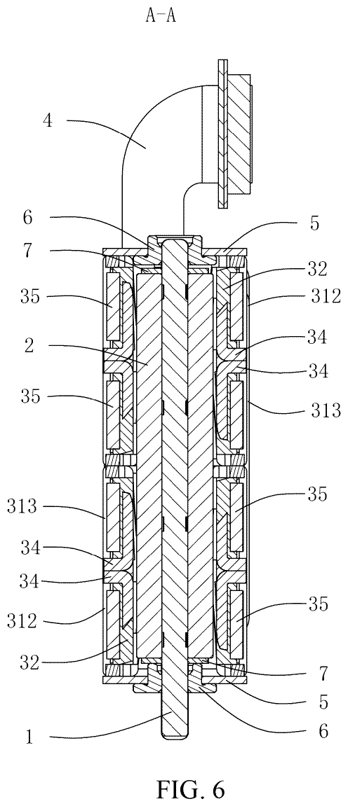

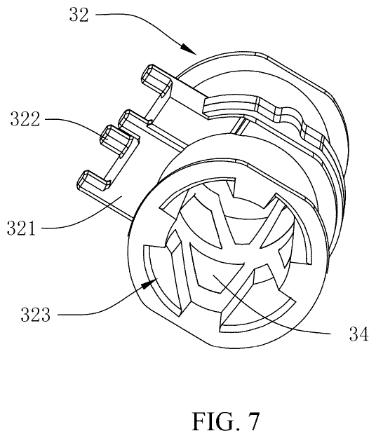

In FIGS. 4-7: 300, step motor; 1, rotary shaft; 2, magnet; 3, winding; 31, shell; 311, slot; 312, first shell; 313, second shell; 314, shallow slot; 32, skeleton; 321, extension; 322, winding post; 323, groove; 33, first claw pole; 331, fixed portion; 332, bending portion; 34, second claw pole; 35, coil; 4, flexible circuit board; 5, cover body; 51, notch; 6, bearing; 7, gasket.

### DESCRIPTION OF EMBODIMENTS

The technical solutions in embodiments of the present disclosure will be described clearly and completely below in conjunction with the accompanying drawings in the embodiments of the present disclosure. It should be clear that the described embodiments are just some, rather than all, of the embodiments of the present disclosure. Based on the embodiments of the present disclosure, all other embodiments obtained by one of ordinary skill in the art without any creative effort shall fall within the protection scope of the present disclosure.

An embodiment of the present disclosure provides a step motor 300 including a rotary shaft 1, a magnet 2 fixed to an outer peripheral side of the rotary shaft 1, a winding unit sleeved on the rotary shaft 1 and forming a rotatable connection with the rotary shaft 1, and a flexible circuit board 4 fixed to the winding unit and forming an electrical connection with the winding unit, as shown in conjunction with FIG. 4 to FIG. 7. The winding unit includes at least one winding 3 arranged along an axial direction of the rotary shaft 1. Each winding 3 is disposed apart from the magnet 2.

The magnet 2 is a sintered magnet. The magnetic remanence of the magnet 2 is one of the factors affecting the torque performance of the step motor 300. Since the shape of the magnet 2 may be annular or a plurality of magnets 2 may enclose to form an annular shape with a smaller diameter, if the magnet 2 is fixed by means of bonding, the magnetic remanence of the magnet 2 would be lower, which is not conducive to improving the torque performance of the step motor 300. Whereas the magnet 2 in the embodiment adopts a sintered magnet, the magnetic remanence of the magnet 2 has been improved by more than 50% compared with the magnetic remanence of the magnet 2 fixed by means of bonding, which can effectively improve the torque performance of the step motor 300, and is suitable for the situation where the size of the step motor 300 in a single direction is limited.

Of course, fixing the magnet 2 by means of bonding also has the advantages that mold imaging is convenient to prepare, multipole magnetization can be carried out, it is simple and convenient, and mass production is facilitated. Adapting the sintered magnet also has disadvantages that direct mold-forming cannot be carried out and multipole magnetization cannot be carried out, slicing→magnetizing→pasting→grinding→powder removing→electroplating need to be sequentially carried out, the process is complex and immature, and the cost is higher.

The step motor includes a plurality of magnets 2 disposed around the rotary shaft 1 and fixed to the outer peripheral side of the rotary shaft 1. The plurality of magnets 2 are arranged at intervals. In this embodiment, the number of the magnets 2 is eight and they are disposed at equal intervals. Of course, the number of the magnets 2 may also be adaptively modified based on actual demands.

In particular, each winding 3 includes a shell 31 sleeved on the rotary shaft 1 and forming a rotatable connection with the rotary shaft 1, a skeleton 32 fixed to an inner side of the shell 31 and disposed coaxially with the shell 31, two first claw poles 33 respectively fixed to two ends of the shell 31, two second claw poles 34 fixed to a middle region of the skeleton 32, and two coils 35 respectively wound around an outer peripheral side of the skeleton 32 and disposed at intervals. The shell 31 has an annular shape and is formed by enclosing its sidewall. Each of the second claw poles 34 extends into the skeleton 32 and forms a fixed connection with the skeleton 32. Each of the first claw poles 33 is disposed opposite to and fit with a corresponding one of the second claw poles 34. Each of the coils 35 is located at an outer side of a corresponding one of the first claw poles 33 and an outer side of a corresponding one of the second claw poles 34. Two opposite sides of the shell 31 of each of the at least one winding 3 each is provided with a slot 311 penetrating through the sidewall of the shell.

The flexible circuit board 4 is fixed to the skeleton 32 of each winding 3, and the flexible circuit board 4 is electrically connected to all the coils 35 of each winding 3.

The middle region of the skeleton 32 of each winding 3 is provided with an extension 321 protruding and passing through the shell 31. A side of the extension 321 away from the skeleton 32 is provided with four winding posts 322 protruding at intervals, and the four winding posts 322 are respectively inserted and fixed to the flexible circuit board 4. Two ends of each of the two coils 35 of each winding 3 are respectively wound around two of the four winding posts 322 and form electrical connections with the flexible circuit board 4.

The winding posts 322 and the extension 321 of each winding 3 are integrally molded with the skeleton 32 by injection molding. This design mode adopts integral molding of plastic pins, and abandons the mode of insert injection integral molding of metal pins adopted in the related art, avoiding the drawback that the metal pins are unstable and easy to fall off when they are small in size.

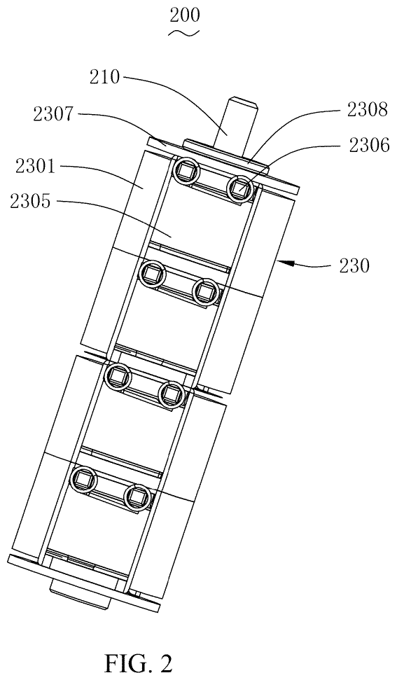

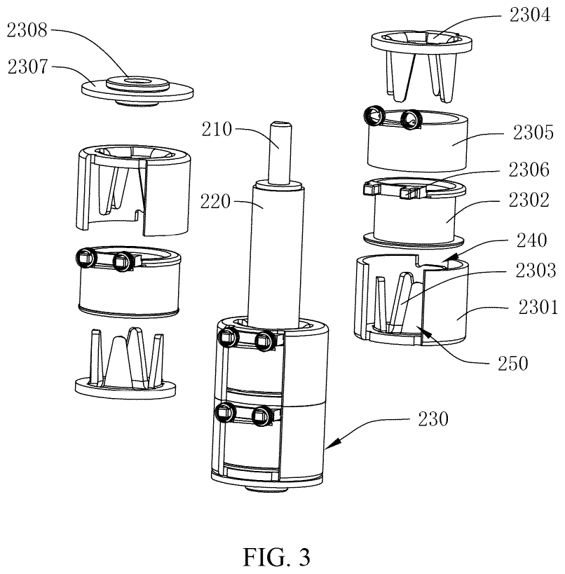

As shown in conjunction with FIG. 2 and FIG. 3, the coil structure 2305, the first claw pole structure 2303, and the second claw pole structure 2304 of the motor 200 in the related art are separate parts, the coil structure 2305 is wound and fixed to the bracket 2302, the four coil structures 2305 are installed in sequence, and the winding posts 2306 are uniformly arranged in one direction. The disadvantages are that the sidewall of the housing 2301 must be provided with the large slot 250 for avoidance, which causes the torque performance of the motor 200 not to be fully improved and the side space to be occupied; and the bracket 2302 is injection molded and the radial thickness of the bracket 2302 needs to be at least 0.15 mm, which wastes the arrangement space.

In the embodiment, the two second claw poles 34 of each winding 3 are each embedded into a corresponding skeleton 32, and are each integrally molded with the corresponding skeleton 32 by insert injection molding. In this design mode, the radial thickness of the skeleton 32 can be reduced to 0.08 mm, which effectively improves the magnetic circuit space of the step motor 300; and the shell 31 is installed from both sides of the coil 35, so that there is no need to provide a large slot, and only a shallow slot 314 needs to be provided to meet the assembly requirements, which effectively increases the volume of the sidewall of the shell 31 and effectively improves the torque performance of the step motor 300.

Each of the first claw poles 33 is integrally molded with the shell 31 corresponding to the first claw poles 33.

Each of the first claw poles 33 and each of the second claw poles 34 each includes an annular fixed portion 331 and a plurality of bending portions 332 extending and bent from an inner periphery of the fixed portion 331 along an axial direction of the fixed portion 331, and the plurality of bending portions 332 are provided at intervals and all extend into the skeleton 32. The bending portions 332 of each of the first claw poles 33 are each located between two of the bending portions 332 of a corresponding one of the second claw poles 34, and the bending portions 332 of each of the second claw poles 34 are each located between two of the bending portions 332 of a corresponding one of the first claw poles 33.

The fixed portion 331 of each first claw pole 33 is fixed to one end of the shell 31, and the fixed portion 331 of each second claw pole 34 is fixed to the middle region of the corresponding skeleton 32. Such a design can ensure the stability of the first claw pole 33 and the second claw pole 34, and enable both of them to extend into the skeleton 32 to adapt to a corresponding coil 35.

An inner side of the skeleton 32 of each winding 3 is provided with a plurality of grooves 323 formed by recessing inward. The plurality of grooves 323 respectively match the plurality of bending portions 332 of each of the first claw poles 33 and the plurality of bending portions 332 of each of the second claw poles 34 in shape, and the plurality of bending portions 332 of each of the first claw poles 33 and the plurality of bending portions 332 of each of the second claw poles 34 are each accommodated and fixed in a corresponding groove 323. In such a design, the first claw poles 33 and the second claw poles 34 can be respectively limited by the grooves 323 designed in the skeleton 32.

In particular, the winding unit includes a plurality of windings 3 arranged along the axial direction of the rotary shaft 1, the shells 31 of the plurality of windings 3 are fixedly connected to one another in sequence, and the respective slots 311 of the plurality of windings 3 lead to each other along the axial direction of the rotary shaft 1. In the embodiment, the winding unit includes two windings 3.

The shell 31 of each winding 3 includes a first shell 312 and a second shell 313 that are hollow and mutually overlapped along the axial direction of the rotary shaft 1. The slots 311 are respectively disposed in the first shell 312 and the second shell 313. Each of two outer windings of the windings 3 further includes a cover body 5 that covers and is fixed to one end of the first shell 312 away from the second shell 313. In each of the two outer windings 3, the first shell 312 is further away from another one of the windings 3 than the second shell 313. The cover body 5 is fixed to the rotary shaft 1 through a bearing 6 and forms a rotatable connection with the rotary shaft 1. The cover body 5 is provided with an inwardly recessed notch 51 in a position of the cover body 5 corresponding to the slots 311. The two first claw poles 33 of each winding 3 are respectively disposed at an end of the first shell 312 and an end of the second shell 313 which are away from each other. Such a design can not only facilitate the formation of the rotatable connection between the shell 31 and the rotary shaft 1, but also facilitate the disassembly and assembly of the shell 31 and the design of the slots 311.

In addition, the step motor 300 further includes two gaskets 7 sleeved on the rotary shaft 1 and spaced apart from each other, and the two gaskets 7 respectively abut against two ends of the magnet(s) 2. In such a design, the fixed strength between the magnet(s) 2 and the rotary shaft 1 can be reinforced.

The step motor 300 in the embodiment may be applied to an automatic folding hinge of a foldable-screen mobile phone.

Compared with the related art, for the step motor 300 in the embodiment, each of the second claw poles 34 is fixed to the skeleton 32 to achieve position limitation, and the slots 311 penetrating through the sidewall of the shell 31 are provided on the two opposite sides of the shell 31 to achieve avoidance in a single direction, so that the step motor 300 can further expand the volumes of the magnet(s) 2, the first claw poles 33, the second claw poles 34, and the coils 35 when it is of the same size. Although the volume of the sidewall of the shell 31 is reduced, on the whole, the space of the effective magnetic circuit formed by the magnet(s) 2 and the coils 35 is released, so that the effective volume of the entire magnetic circuit is increased, and the torque performance can also be improved by around 15%.

The above are merely the embodiments of the present disclosure. It should be noted that for one of ordinary skill in the art, improvements can be further made without departing from the inventive concept of the present disclosure, and all of these shall fall within the protection scope of the present disclosure.

What is claimed is:

1. A step motor, comprising: a rotary shaft, a magnet fixed to an outer peripheral side of the rotary shaft, and a winding unit sleeved on the rotary shaft and forming a rotatable connection with the rotary shaft, the winding unit comprising at least one winding arranged along an axial direction of the rotary shaft, and each winding being disposed apart from the magnet;
wherein each winding comprises a shell sleeved on the rotary shaft and forming a rotatable connection with the rotary shaft, a skeleton fixed to an inner side of the shell and disposed coaxially with the shell, two first claw poles respectively fixed to two ends of the shell, two second claw poles fixed to a middle region of the skeleton, and two coils respectively wound around an outer peripheral side of the skeleton and disposed at intervals; the shell has an annular shape and is formed by enclosing its sidewall, each of the second claw poles extends into the skeleton and forms a fixed connection with the skeleton, each of the first claw poles is disposed opposite to and fit with a corresponding one of the second claw poles, and each of the coils is located at an outer side of a corresponding one of the first claw poles and an outer side of a corresponding one of the second claw poles; and two opposite sides of the shell of each winding each is provided with a slot penetrating through the sidewall of the shell.

2. The step motor as described in claim 1, wherein the two second claw poles of each winding are each embedded into a corresponding skeleton, and are each integrally molded with the corresponding skeleton by insert injection molding.

3. The step motor as described in claim 1, further comprising a flexible circuit board fixed to the winding unit and forming an electrical connection with the winding unit, wherein the flexible circuit board is fixed to the skeleton of each winding, and the flexible circuit board is electrically connected to all the coils of each winding.

4. The step motor as described in claim 3, wherein the middle region of the skeleton of each winding is provided with an extension protruding and passing through the shell, wherein a side of the extension away from the skeleton is provided with four winding posts protruding at intervals, and the four winding posts are respectively inserted and fixed to the flexible circuit board; and two ends of each of the two coils of each winding are respectively wound around two of the four winding posts and form electrical connections with the flexible circuit board.

5. The step motor as described in claim 4, wherein the winding posts and the extension of each winding are integrally molded with the skeleton by injection molding.

6. The step motor as described in claim 1, wherein the magnet is a sintered magnet.

7. The step motor as described in claim 6, wherein the step motor includes a plurality of magnets, the plurality of magnets are disposed around the rotary shaft and fixed to the outer peripheral side of the rotary shaft, and the plurality of magnets are arranged at intervals.

8. The step motor as described in claim 1, wherein each of the first claw poles and each of the second claw poles each comprises an annular fixed portion and a plurality of bending portions extending and bent from an inner periphery of the fixed portion along an axial direction of the fixed portion, and the plurality of bending portions are provided at intervals and all extend into the skeleton; and the bending portions of each of the first claw poles are each located between two of the bending portions of a corresponding one of the second claw poles, and the bending portions of each of the second claw poles are each located between two of the bending portions of a corresponding one of the first claw poles.

9. The step motor as described in claim 8, wherein an inner side of the skeleton of each winding is provided with a plurality of grooves formed by recessing inward, the plurality of grooves respectively match the plurality of bending portions of each of the first claw poles and the plurality of bending portions of each of the second claw poles in shape, and the plurality of bending portions of each of the first claw poles and the plurality of bending portions of each of the second claw poles are each accommodated and fixed in a corresponding groove.

10. The step motor as described in claim 1, wherein each of the first claw poles is integrally molded with the shell corresponding to the first claw poles.

11. The step motor as described in claim 1, wherein the winding unit comprises a plurality of windings arranged along the axial direction of the rotary shaft, the shells of the plurality of windings are fixedly connected to one another in sequence, and the respective slots of the plurality of windings lead to each other along the axial direction of the rotary shaft.

12. The step motor as described in claim 11, wherein the shell of each winding comprises a first shell and a second shell that are hollow and mutually overlapped along the axial direction of the rotary shaft, and the slots are respectively disposed in the first shell and the second shell; each of two outer windings of the windings further comprises a cover body that covers and is fixed to one end of the first shell away from the second shell, in each of the two outer windings, the first shell is further away from another one of the windings than the second shell, the cover body is fixed to the rotary shaft through a bearing and forms a rotatable connection with the rotary shaft, and the cover body is provided with an inwardly recessed notch in a position of the cover body corresponding to the slots; and the two first claw poles of each winding are respectively disposed at an end of the first shell and an end of the second shell which are away from each other.
